(19) United States
(12) Patent Application Publication
(10) Pub. No.: US 2014/0108766 A1
(43) Pub. Date: Apr. 17, 2014

(54) PREFETCHING TABLEWALK ADDRESS TRANSLATIONS

(71) Applicant: Advanced Micro Devices, Inc., Sunnyvale, CA (US)

(72) Inventor: Nischal Desai, Austin, TX (US)

(21) Appl. No.: 13/654,034

(22) Filed: Oct. 17, 2012

(51) Int. Cl. G06F 12/02

(52) U.S. Cl. 711/205; 711/E12.004

(57) ABSTRACT

A processing unit includes a translation look-aside buffer operable to store a plurality of virtual address translation entries, a prefetch buffer, and logic operable to receive a first virtual address translation associated with a first virtual memory block and a second virtual address translation associated with a second virtual memory block immediately adjacent the first virtual memory block, store the first virtual address translation in the transaction look-aside buffer, and store the second virtual address translation in the prefetch buffer.

### BACKGROUND

The disclosed subject matter relates generally to computing systems and processing devices and, more particularly, to a method and apparatus for prefetching tablewalk address translations.

A typical computer system includes a memory hierarchy to obtain a relatively high level of performance at a relatively low cost. Instructions of different software programs are typically stored on a relatively large but slow non-volatile storage unit (e.g., a disk drive unit). When a user selects one of the programs for execution, the instructions of the selected program are copied into a main memory, and a processor (e.g., a central processing unit or CPU) obtains the instructions of the selected program from the main memory. Some portions of the data are also loaded into cache memories of the processor or processors in the system.

A cache is a smaller and faster memory that stores copies of instructions and/or data that are expected to be used relatively frequently. For example, central processing units (CPUs) are generally associated with a cache or a hierarchy of cache memory elements. Processors other than CPUs, such as, for example, graphics processing units (GPUs) and others, are also known to use caches.

Well-known virtual memory management techniques allow a processing unit to access data structures larger in size than that of the main memory by storing only a portion of the data structures within the main memory and/or cache memories at any given time. Remainders of the data structures are stored within the relatively large but slow non-volatile storage unit, and are copied into the main memory and/or cache memories only when needed.

Virtual memory is typically implemented by dividing an address space of the processor into multiple blocks called page frames or “pages.” Only data corresponding to a portion of the pages is stored within the main memory and/or the caches at any given time. When the processor generates an address within a given page, and a copy of that page is not located within the main memory, the required page of data is copied from the relatively large but slow non-volatile storage unit into the main memory. When caches are employed, the page is also copied to the cache. In the process, another page of data may be flushed from the main memory or cache to make room for the required page.

Processors typically include specialized hardware elements to support implementation of virtual memory. Such processors produce virtual addresses, and implement virtual-to-physical address translation mechanisms to “map” the virtual addresses to physical addresses of memory locations in the main memory. The address translation mechanisms typically include one or more data structures (i.e., “page tables”) arranged to form a hierarchy. The page tables are typically stored in the main memory and are maintained by operating system software. A highest-ordered page table is located within the main memory. Where multiple page tables are used to perform the virtual-to-physical address translation, entries of the highest-ordered page table are base addresses of other page tables. Any additional page tables may be obtained from the storage unit and stored in the main memory as needed.

A base address of a memory page containing the highest-ordered page table is typically stored in a register. The highest-ordered page table includes multiple entries. The entries may be base addresses of other page tables, or base addresses of pages including physical addresses corresponding to virtual addresses. A virtual address produced by the processor is divided into multiple portions, and the portions are used as indexes into the page tables. A lowest-ordered page table includes an entry storing a base address of the page including the physical address corresponding to the virtual address. The physical address is formed by adding a lowest-ordered or “offset” portion of the virtual address to the base address in the selected entry of the lowest-ordered page table.

The above described virtual-to-physical address translation mechanism requires accessing one or more page tables in main memory (i.e., page table “lookups” or “walks”). Such page table accesses require significant amounts of time, and negatively impact processor performance. Consequently, processors typically include a translation look-aside buffer (TLB) for storing the most recently used page table entries. TLB entries are typically maintained by the operating system. Inclusion of the TLB significantly increases processor performance.

Virtual memory systems are also employed in multiprocessor systems including multiple processors, such as CPU cores, graphics processing units (GPUs), digital signal processors (DSPs), application specific integrated circuits (ASICs), etc. Such multiprocessor systems may advantageously have a main memory shared by all of the processing units. The ability of all processing units to access instructions and data (i.e., “code”) stored in the shared main memory eliminates the need to copy code from one memory accessed exclusively by one processing unit to another memory accessed exclusively by another processing unit. In a multiprocessor environment, each processing unit may include its own TLB.

Although the use of a TLB reduces the need for table walks to translate between virtual and physical addresses, the size of the TLB is limited. A miss in the TLB induces a delay while a table walk is completed. Increasing the size of the TLB to reduce latency caused by table walks increases silicon real estate usage.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY OF EMBODIMENTS

The following presents a simplified summary of only some aspects of embodiments of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a processing unit includes a translation look-aside buffer operable to store a plurality of virtual address translation entries, a prefetch buffer, and logic operable to receive a first virtual address translation associated with a first virtual memory block and a second virtual address translation associated with a second virtual memory block immediately adjacent the first virtual memory block, store the first virtual address translation in the transaction look-aside buffer, and store the second virtual address translation in the prefetch buffer.

In some embodiments, a computer system includes a system memory operable to store a table of virtual address translations and a processing unit operable to address physical memory locations in the system memory using virtual addresses. The processing unit includes a translation look-aside buffer operable to store a plurality of virtual address translation entries, a prefetch buffer, and logic operable to receive a first virtual address translation associated with a first virtual memory block and a second virtual address translation associated with a second virtual memory block immediately adjacent the first virtual memory block from the table of virtual address translations, store the first virtual address translation in the transaction look-aside buffer, and store the second virtual address translation in the prefetch buffer.

In some embodiments, a method for prefetching tablewalk address translations includes storing a plurality of virtual address translation entries in a translation look-aside buffer. A first virtual address translation associated with a first virtual memory block and a second virtual address translation associated with a second virtual memory block immediately adjacent the first virtual memory block are received. The first virtual address translation is stored in the transaction look-aside buffer. The second virtual address translation is stored in a prefetch buffer.

### BRIEF DESCRIPTION OF THE DRAWINGS

The disclosed subject matter will hereafter be described with reference to the accompanying drawings, wherein like reference numerals denote like elements, and:

FIG. 1 is a simplified block diagram of a computer system in accordance with some embodiments of the present subject matter;

FIG. 2 is a simplified block diagram of translation look-aside buffer circuitry used in the system of FIG. 1, in accordance with some embodiments; and

FIG. 3 is a simplified diagram of a computing apparatus that may be programmed to direct the fabrication of the integrated circuit device of FIGS. 1 and 2, in accordance with some embodiments; and

FIG. 4 is a simplified flow diagram of a method for prefetching tablewalk address translations in accordance with some embodiments of the present subject matter.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

One or more embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers'specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

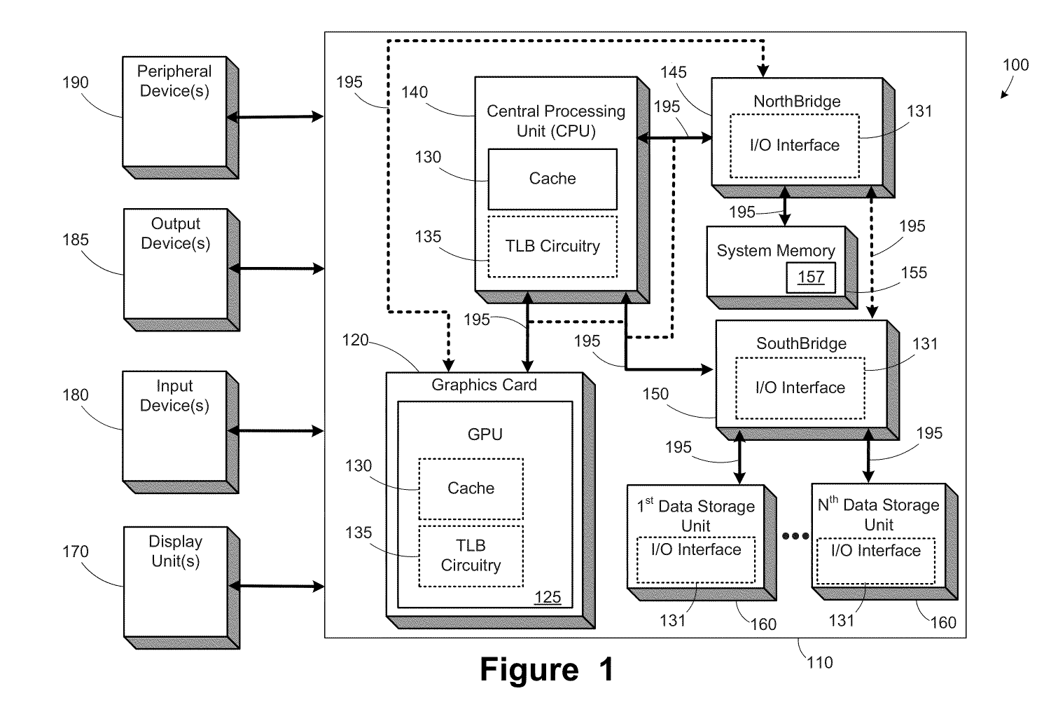

Referring now to the drawings wherein like reference numbers correspond to similar components throughout the several views and, specifically, referring to FIG. 1, the disclosed subject matter shall be described in the context of an example computer system 100, in accordance with some embodiments of the present subject matter. In various embodiments the computer system 100 may be a personal computer, a laptop computer, a handheld computer, a tablet computer, a mobile device, a telephone, a personal data assistant (“FDA”), a server, a mainframe, a work terminal, a music player, a smart television, and/or the like. The computer system 100 includes a main structure 110 which may be a computer motherboard, circuit board or printed circuit board, a desktop computer enclosure and/or tower, a laptop computer base, a server enclosure, part of a mobile device, personal data assistant (PDA), or the like. In some embodiments, the main structure 110 includes a graphics card 120. In some embodiments, the graphics card 120 may be a Radeon™ graphics card from Advanced Micro Devices (“AMD”) or any other graphics card using memory, in alternate embodiments. The graphics card 120 may, in different embodiments, be connected on a Peripheral Component Interconnect “(PCI”) Bus (not shown), PCI-Express Bus (not shown) an Accelerated Graphics Port (“AGP”) Bus (also not shown), or any other computer system connection. It should be noted that embodiments of the present application are not limited by the connectivity of the graphics card 120 to the main computer structure 110. In some embodiments, the computer system 100 runs an operating system such as Linux, UNIX, Windows, Mac OS, and/or the like. In some embodiments, the computer system 100 may include one or more system registers (not shown) adapted to store values used by the computer system 100 during various operations.

In some embodiments, the graphics card 120 may contain a processing device such as a graphics processing unit (GPU) 125 used in processing graphics data. The GPU 125, in some embodiments, may include one or more embedded/non-embedded memories, such as one or more caches 130. The GPU caches 130 may be L1, L2, higher level, graphics specific/related, instruction, data and/or the like. In various embodiments, the embedded memory(ies) may be implemented using embedded random access memory (“RAM”), an embedded static random access memory (“SRAM”), or an embedded dynamic random access memory (“DRAM”). In alternate embodiments, the memory(ies) may be on the graphics card 120 in addition to, or instead of, being embedded in the GPU 125, for example as DRAM on the graphics card 120. In various embodiments the graphics card 120 may be referred to as a circuit board or a printed circuit board or a daughter card or the like.

In some embodiments, the computer system 100 includes a processing device such as a central processing unit (“CPU”) 140, which may be connected to a northbridge 145. In various embodiments, the CPU 140 may be a single- or multi-core processor, or may be a combination of one or more CPU cores and a GPU core on a single die/chip (such an AMD Fusion™ APU device). The CPU 140 may be of an x86 type architecture, an ARM type processor, and/or the like. In some embodiments, the CPU 140 may include one or more cache memories 130, such as, but not limited to, L1, L2, Level 3 or higher, data, instruction and/or other cache types. In some embodiments, the CPU 140 may be a pipe-lined processor. The CPU 140 and northbridge 145 may be housed on the motherboard (not shown) or some other structure of the computer system 100. It is contemplated that in certain embodiments, the graphics card 120 may be coupled to the CPU 140 via the northbridge 145 or some other computer system connection. For example, the CPU 140, the northbridge 145, and the GPU 125 may be included in a single package or as part of a single die or “chips” (not shown) or as a combination of packages. In the case of an integrated GPU, the graphics card 120 may be omitted, and the GPU 125 may be part of the CPU 140. Alternative embodiments which alter the arrangement of various components illustrated as forming part of main structure 110 are also contemplated. In certain embodiments, the northbridge 145 may be coupled to a system memory 155 (e.g., DRAM); in other embodiments, the system memory 155 may be coupled directly to the CPU 140. The system memory 155 may be of any RAM type known in the art and may comprise one or more memory modules; the type of RAM does not limit the embodiments of the present application. For example, the system memory 155 may include one or more DIMMs. As referred to in this description, a memory may be a type of RAM, a cache or any other data storage structure referred to herein.

In some embodiments, the northbridge 145 may be connected to a southbridge 150. In other embodiments, the northbridge 145 and southbridge 150 may be on the same chip in the computer system 100, or the northbridge 145 and southbridge 150 may be on different chips. In some embodiments, the southbridge 150 may have one or more I/O interfaces 131, in addition to any other I/O interfaces 131 elsewhere in the computer system 100. In various embodiments, the southbridge 150 may be connected to one or more data storage units 160 using a data connection or bus 195. The data storage units 160 may be hard drives, solid state drives, magnetic tape, or any other writable media used for storing data. In some embodiments, one or more of the data storage units may be USB storage units and the data connection 195 may be a USB bus/connection. Additionally, the data storage units 160 may contain one or more I/O interfaces 131. In various embodiments, the central processing unit 140, northbridge 145, southbridge 150, graphics processing unit 125, system memory 155 and/or embedded RAM may be a computer chip or a silicon-based computer chip, or may be part of a computer chip or a silicon-based computer chip. In one or more embodiments, the various components of the computer system 100 may be operatively, electrically and/or physically connected or linked with a bus 195 or more than one bus 195.

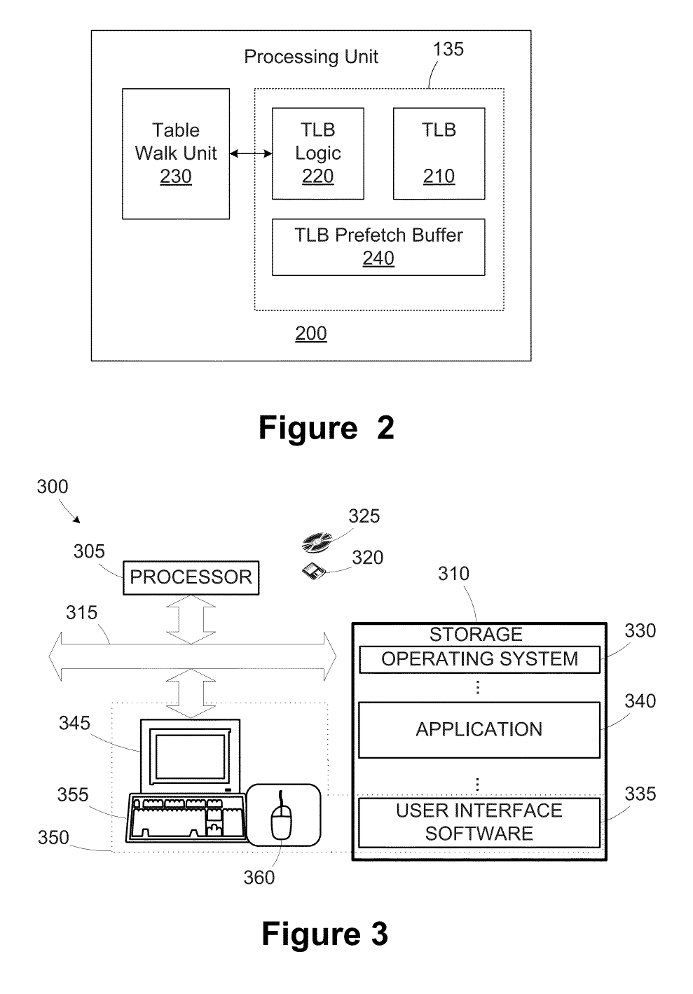

In one or more embodiments, the computer system 100 may include translation look-aside buffer (TLB) circuitry 135. The TLB circuitry 135 may be provided for each of the processing units (e.g., CPU 140, GPU 125) that employ virtual addresses for accessing the system memory 155. The components of the TLB circuitry 135 are discussed in further detail below in FIG. 2. The TLB circuitry 135 may comprise a silicon die/chip and may include software, hardware and/or firmware components. In different embodiments, the TLB circuitry 135 may be packaged in any silicon die package or electronic component package as would be known to a person of ordinary skill in the art having the benefit of this disclosure. In alternate embodiments, the TLB circuitry 135 may be a circuit included in an existing computer component, such as, but not limited to, the CPU 140, the northbridge 145, the graphics card 120 and/or the GPU 125. In some embodiments, TLB circuitry 135 may be communicatively coupled to the CPU 140, the northbridge 145, the system memory 155 and/or their respective connections 195. As used herein, the terms “TLB circuitry” or “TLB” (e.g., TLB circuitry 135) may be used to refer a physical TLB chip or to TLB circuitry included in a computer component, to circuitry of the TLB circuitry 135, or to the functionality implemented by the TLB. In accordance with one or more embodiments, the TLB circuitry 135 may function as, and/or be referred to as, a portion of a processing device. In some embodiments, some combination of the GPU 125, the CPU 140, the TLB circuitry 135 and/or any hardware/software computer 100 units respectively associated therewith, may collectively function as, and/or be collectively referred to as, a processing device. In some embodiments, the CPU 140 and TLB circuitry 135, or the CPU 140, the northbridge 145 and the TLB circuitry 135 and their respective interconnects may function as a processing device. In other embodiments, the CPU 140, GPU 125, the northbridge 145, etc. may be considered as separate processing units.

In some embodiments, the computer system 100 may be connected to one or more display units 170, input devices 180, output devices 185 and/or other peripheral devices 190. It is contemplated that in various embodiments, these elements may be internal or external to the computer system 100, and may be wired or wirelessly connected, without affecting the scope of the embodiments of the present application. The display units 170 may be internal or external monitors, television screens, handheld device displays, and the like. The input devices 180 may be any one of a keyboard, mouse, track-ball, stylus, mouse pad, mouse button, joystick, scanner or the like. The output devices 185 may be any one of a monitor, printer, plotter, copier or other output device. The peripheral devices 190 may be any other device which can be coupled to a computer: a CD/DVD drive capable of reading and/or writing to corresponding physical digital media, a universal serial bus (“USB”) device, Zip Drive, external floppy drive, external hard drive, phone and/or broadband modem, router/gateway, access point and/or the like. The input, output, display and peripheral devices/units described herein may have USB connections in some embodiments. To the extent certain example aspects of the computer system 100 are not described herein, such example aspects may or may not be included in various embodiments without limiting the spirit and scope of the embodiments of the present application as would be understood by one of skill in the art.

Turning now to FIG. 2, a block diagram of an example processing unit 200 (e.g., CPU 140, GPU 125, DSP, ASIC, or a different type of processing unit) including an example TLB circuitry 135 is illustrated. The TLB circuitry 135 includes a translation look-aside buffer 210 for storing a set of recently used virtual to physical address translations and TLB logic 220 for accessing the translation look-aside buffer 210 to identify matches and for handling the replacement policy for new entries. Although the TLB logic 220 is illustrated as being separate from the translation look-aside buffer 210, it may be integrated therewith. Because, the translation look-aside buffer 210 has a fixed number of entries, a requested virtual address may result in a miss. In the event that a miss occurs, the TLB logic 220 interfaces with a table walk unit 230 to retrieve the requested virtual address translation. As known to those of ordinary skill in the art, the table walk unit 230 accesses one or more translation tables 157 that are typically stored in the system memory 155 to identify the virtual-to-physical address translation. Because, the tables are stored in the system memory 155, the table walking process is relatively slow. Hence, there is a significant delay caused by a miss in the translation look-aside buffer 210.

Because a process thread (i.e., particular software application) serviced by the processor 140, 200 typically follows a locality of references pattern, it is often the case that the processor 140, 200 will request sequential pages of virtual memory. In response to a miss in the translation look-aside buffer 210, the TLB logic 220 sends a lookup request for the virtual address translation for the missed page, as well as the virtual address translation for the next sequential page. The page size used in the memory subsystem may vary depending on the particular architecture and implementation. The term page simply refers to a block of memory locations. The page is typically contiguous, and is generally the smallest block size for a memory transaction. In the illustrated embodiment, the page size is 4K bytes. Of course, other page sizes may be used.

The virtual address translation for the page associated with the TLB miss is stored in the TLB 210 in accordance with the conventional replacement policy. The prefetched address translation (i.e., for the next sequential page) is stored in a TLB prefetch buffer 240. The TLB prefetch buffer 240 may be separate from the TLB 210, or may be implemented using a designated location in the TLB 210. In the illustrated embodiment, the TLB prefetch buffer 240 stores a single entry for the next sequential page address translation. However, it is contemplated that the TLB prefetch buffer 240 may be operable to store more than one entry and the TLB logic 220 and table walk unit 230 may be operable to provide more than one prefetch virtual address translation (i.e., N prefetch virtual address translations corresponding to N entries in the TLB prefetch buffer 240).

In some embodiments, the table walk unit 230 is operable to respond to any virtual address translation lookup request with at least two responses, one for the current virtual address translation and a second virtual address translation for the next sequential page(s) in virtual memory. This approach requires that both the TLB logic 220 and the table walk unit 230 be configured to handle the prefetching.

In another embodiment, the TLB logic 220 may be operable to issue at least two sequential lookup requests, one for the current virtual address translation and additional lookup requests for the prefetch virtual address translation of the next page(s). In this approach, the table walk unit 230 may be conventional in the sense that it will service the requests in order without realizing that prefetching is being implemented. However, using this approach the latency increases as two or more requests need to be serviced, as compared to a single lookup request with two or more responses. The additional latency may be an issue if the processor 140, 200 needs the second virtual address translation prior to the additional lookup request(s) being serviced.

The TLB prefetch buffer 240 operates in a FIFO fashion. If only one entry is stored, the entry will be overwritten with every prefetch. If the TLB prefetch buffer 240 has a depth greater than one, the oldest entry will be overwritten in response to a new prefetch.

When servicing an incoming TLB request, the TLB logic 220 first checks the TLB 210 to determine if a corresponding entry is present. If a miss occurs in the TLB 210, the TLB logic 220 checks the TLB prefetch buffer 240 to identify a hit. If a match is found, then a hit is reported, and the virtual address translation is supplied from the TLB prefetch buffer 240. In some embodiments, the TLB logic 220 may move the virtual address translation associated with a hit in the TLB prefetch buffer 240 into the TLB 210, however, in other embodiments, the entry will remain in the TLB prefetch buffer 240 until it is replaced by another prefetch. Storing the prefetched virtual address translation in the TLB prefetch buffer 240 avoids the replacement of an entry in the TLB 210 with the more speculative prefetch virtual address translation.

Prefetching and storing the virtual address translation for the subsequent virtual address page decreases latency for program threads that are executing in a locality of references manner. Because the TLB prefetch buffer 240 may be populated without replacing an entry in the TLB 210, there is no penalty for a speculative prefetch that is not actually needed.

FIG. 3 illustrates a simplified diagram of selected portions of the hardware and software architecture of a computing apparatus 300 such as may be employed in some aspects of the present subject matter. The computing apparatus 300 includes a processor 305 communicating with storage 310 over a bus system 315. The storage 310 may include a hard disk and/or random access memory (RAM) and/or removable storage, such as a magnetic disk 320 or an optical disk 325. The storage 310 is also encoded with an operating system 330, user interface software 335, and an application 340. The user interface software 335, in conjunction with a display 345, implements a user interface 350. The user interface 350 may include peripheral I/O devices such as a keypad or keyboard 355, mouse 360, etc. The processor 305 runs under the control of the operating system 330, which may be practically any operating system known in the art. The application 340 is invoked by the operating system 330 upon power up, reset, user interaction, etc., depending on the implementation of the operating system 330. The application 340, when invoked, performs a method of the present subject matter. The user may invoke the application 340 in conventional fashion through the user interface 350. Note that although a stand-alone system is illustrated, there is no need for the data to reside on the same computing apparatus 300 as the simulation application 340 by which it is processed. Some embodiments of the present subject matter may therefore be implemented on a distributed computing system with distributed storage and/or processing capabilities.

It is contemplated that, in some embodiments, different kinds of hardware descriptive languages (HDL) may be used in the process of designing and manufacturing very large scale integration circuits (VLSI circuits), such as semiconductor products and devices and/or other types semiconductor devices. Some examples of HDL are VHDL and Verilog/Verilog-XL, but other HDL formats not listed may be used. In some embodiments, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., storage 310, disks 320, 325, solid state storage, and the like). In some embodiments, the GDSII data (or other similar data) may be adapted to configure a manufacturing facility (e.g., through the use of mask works) to create devices capable of embodying various aspects of the disclosed embodiments. In other words, in various embodiments, this GDSII data (or other similar data) may be programmed into the computing apparatus 300, and executed by the processor 305 using the application 365, which may then control, in whole or part, the operation of a semiconductor manufacturing facility (or fab) to create semiconductor products and devices. For example, in some embodiments, silicon wafers containing portions of the computer system 100, 200 illustrated in FIG. 1 or 2 may be created using the GDSII data (or other similar data).

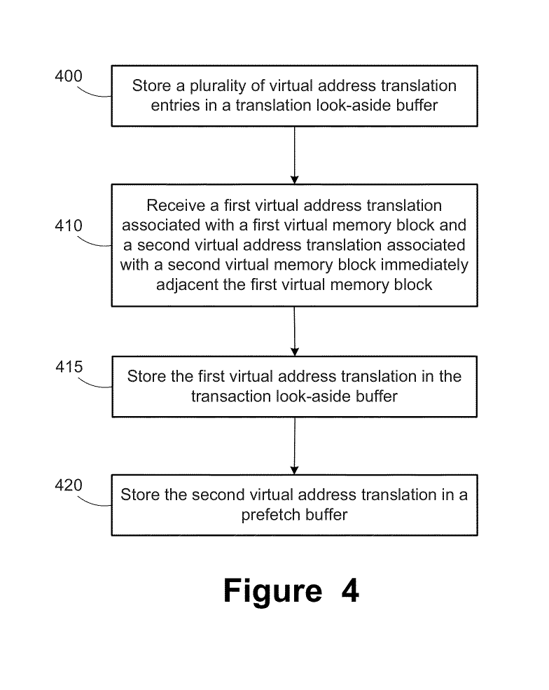

FIG. 4 is a simplified flow diagram of a method for prefetching tablewalk address translations in accordance with some embodiments of the present subject matter. In method block 400, a plurality of virtual address translation entries is stored in a translation look-aside buffer. In method block 410, a first virtual address translation associated with a first virtual memory block and a second virtual address translation associated with a second virtual memory block immediately adjacent the first virtual memory block are received. In method block 420, the first virtual address translation is stored in the transaction look-aside buffer. In method block 430, the second virtual address translation is stored in a prefetch buffer.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A processing unit, comprising:
a translation look-aside buffer operable to store a plurality of virtual address translation entries;
a prefetch buffer; and
logic operable to receive a first virtual address translation associated with a first virtual memory block and a second virtual address translation associated with a second virtual memory block immediately adjacent the first virtual memory block, store the first virtual address translation in the transaction look-aside buffer, and store the second virtual address translation in the prefetch buffer.

2. The processing unit of claim 1, wherein the logic is operable to issue a lookup request for the first virtual address translation responsive to the translation look-aside buffer and the prefetch buffer not including an entry for a current virtual address translation request received by the logic.

3. The processing unit of claim 2, further comprising a table walk unit operable to receive the lookup request for the first virtual address translation and access a table of virtual address translations to retrieve the first virtual address translation.

4. The processing unit of claim 3, wherein the table walk unit is operable to retrieve the second virtual address translation from the table of virtual address translations responsive to the first lookup request and provide the second virtual address translation to the logic.

5. The processing unit of claim 1, wherein the logic is operable to issue a first lookup request for the first virtual address translation responsive to the translation look-aside buffer and the prefetch buffer not including an entry for a current virtual address translation request and issue a second lookup request for the second virtual address translation subsequent to issuing the first request.

6. The processing unit of claim 5, further comprising a table walk unit operable to receive the first and second lookup requests for the first virtual address translation, access a table of virtual address translations to retrieve the first virtual address translation responsive to the first lookup request and provide the first virtual address translation to the logic, and access the table of virtual address translations to retrieve the second virtual address translation responsive to the second lookup request and provide the second virtual address translation to the logic.

7. The processing unit of claim 1, wherein the prefetch buffer has a plurality of entries.

8. A computer system, comprising:
a system memory operable to store a table of virtual address translations;
a processing unit operable to address physical memory locations in the system memory using virtual addresses, the processing unit comprising:
a translation look-aside buffer operable to store a plurality of virtual address translation entries;
a prefetch buffer; and
logic operable to receive a first virtual address translation associated with a first virtual memory block and a second virtual address translation associated with a second virtual memory block immediately adjacent the first virtual memory block from the table of virtual address translations, store the first virtual address translation in the transaction look-aside buffer, and store the second virtual address translation in the prefetch buffer.

9. The system of claim 8, wherein the logic is operable to issue a lookup request for the first virtual address translation responsive to the translation look-aside buffer and the prefetch buffer not including an entry for a current virtual address translation request received by the logic.

10. The system of claim 9, wherein the processing unit further comprises a table walk unit operable to receive the lookup request for the first virtual address translation and access the table of virtual address translations to retrieve the first virtual address translation.

11. The system of claim 10, wherein the table walk unit is operable to retrieve the second virtual address translation from the table of virtual address translations responsive to the first lookup request and provide the second virtual address translation to the logic.

12. The system of claim 8, wherein the logic is operable to issue a first lookup request for the first virtual address translation responsive to the translation look-aside buffer and the prefetch buffer not including an entry for a current virtual address translation request and issue a second lookup request for the second virtual address translation subsequent to issuing the first request.

13. The system of claim 12, wherein the processing unit further comprises a table walk unit operable to receive the first and second lookup requests for the first virtual address translation, access the table of virtual address translations to retrieve the first virtual address translation responsive to the first lookup request and provide the first virtual address translation to the logic, and access the table of virtual address translations to retrieve the second virtual address translation responsive to the second lookup request and provide the second virtual address translation to the logic.

14. The system of claim 8, wherein the prefetch buffer has a plurality of entries.

15. A method, comprising:
storing a plurality of virtual address translation entries in a translation look-aside buffer;
receiving a first virtual address translation associated with a first virtual memory block and a second virtual address translation associated with a second virtual memory block immediately adjacent the first virtual memory block;
storing the first virtual address translation in the transaction look-aside buffer; and
storing the second virtual address translation in a prefetch buffer.

16. The method of claim 15, further comprising issuing a lookup request for the first virtual address translation responsive to the translation look-aside buffer and the prefetch buffer not including an entry for a current virtual address translation request.

17. The method of claim 16, further comprising accessing a table of virtual address translations to retrieve the first virtual address translation responsive to the lookup request.

18. The method of claim 17, further comprising retrieving the second virtual address translation from the table of virtual address translations responsive to the first lookup request.

19. The method of claim 15, further comprising:
issuing a first lookup request for the first virtual address translation responsive to the translation look-aside buffer and the prefetch buffer not including an entry for a current virtual address translation request; and
issuing a second lookup request for the second virtual address translation subsequent to issuing the first request.

20. The method of claim 19, further comprising:
accessing a table of virtual address translations to retrieve the first virtual address translation responsive to the first lookup request; and
accessing the table of virtual address translations to retrieve the second virtual address translation responsive to the second lookup request.

21. The method of claim 15, wherein the prefetch buffer has a plurality of entries.

22. A computer readable storage device encoded with data that, when implemented in a manufacturing facility, adapts the manufacturing facility to create a processing unit, comprising:
a translation look-aside buffer operable to store a plurality of virtual address translation entries;
a prefetch buffer; and
logic operable to receive a first virtual address translation associated with a first virtual memory block and a second virtual address translation associated with a second virtual memory block immediately adjacent the first virtual memory block, store the first virtual address translation in the transaction look-aside buffer, and store the second virtual address translation in the prefetch buffer.
